(19) United States
(12) Patent Application Publication
(10) Pub. No.: US 2003/0159425 A1
(43) Pub. Date: Aug. 28, 2003

(54) Chain with odd number of links

(76) Inventor: Tetsufumi Matsuura, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/366,797

(22) Filed: Feb. 14, 2003

(30) Foreign Application Priority Data
Feb. 27, 2002 (JP) 51470/2002

(51) Int. Cl. F16G 13/06; B21L 9/02

(52) U.S. Cl. 59/4

(57) ABSTRACT

The respective ends of a chain body composed of alternate inner and outer links are connected to form an endless loop by a connecting link comprising a first pair of connecting plates and a second pair of connecting plates. Two long connecting pins are secured to the second connecting plates. One of the long connecting pins is inserted through a long bushing, which extends through a spacer and is fixed to the first connecting plate. The other long connecting pin extends through a bushing extending through a pair of inner plates of an inner link at one end of the chain body, and spacers are provided between the inner plates and the second connecting plates. The resulting chain has an odd number of links, but lacks the weakness and susceptibility to breakage of conventional chains having odd numbers of links, utilizing offset plates.

### FIELD OF THE INVENTION

This invention relates to a chain having an odd number of links, in which the chain comprises alternating inner links and outer links and is connected to form an endless loop by a connecting link.

### BACKGROUND OF THE INVENTION

In an endless chain composed of inner and outer links, each inner link typically has a pair of bushings fixed to a pair of inner plates. Each outer link is composed of a pair of outer plates to which a pair of connecting pins is secured. The inner and outer links are connected by inserting the connecting pins through the bushings of the inner links, so that the chain is composed of alternating inner and outer links. Such an endless chain is generally formed with an even number of links, because the loop is closed by connecting an inner link to an outer link.

When an endless chain having an even number of links is engaged with a pair of sprockets for power transmission, since the sprocket mounting positions and the distance between the shafts of the sprockets will have already been determined, the chain is frequently not of suitable length. In such a case, the length of the chain is adjusted so that it has an odd number of links. Adjustment is accomplished by connecting an inner link at one end of the chain to an outer link at the other end of the chain through an offset link comprising a pair of plates each having portions that are offset from each other in the direction of the width of the chain. Because of the addition of the offset link, the chain has an odd number of links. The offset plates are usually formed with bent middle portions, and consequently have poor strength. Because of the bent middle portions of the offset plates, when tension is applied to the chain, the chain is liable to break.

A well-known solution to the problem of weakening of the chain due to the bent offset plates, is to provide a reinforcing connecting plate on an outer sides of the offset plates in order to resist tension. This solution is described in registered Japanese utility model publication No. 3047191.

FIG. 7 shows an example of a connecting portion of a chain connected by a conventional offset plate. The chain 31 comprises an even number of links in which inner plates 32 and outer plates 33 are connected to one another by pins 36. To connect the chain links to obtain an endless chain comprising an odd number of links, the ends of chain are respectively connected to an offset link comprising an offset plate 37 and a bushing 35.

Each offset plate 37 includes a bent portion 37a in its middle portion, which connects an outer plate portion 37b at one end to an inner plate portion 37c at the other end. A pin hole 38 is formed in the outer plate portion 37b, and a bushing hole 39 is provided in the inner plate portion 37c. A reinforcing connecting plate 41 is provided on the outside of the offset plate 37. A pin hole 42 is provided in one end portion of plate 41, and a hole 44 for receiving a small bushing 43, through which a pin 40 is inserted, is provided in the other end portion of plate 41.

Each end of the left-hand pin 36 in FIG. 7, is inserted through a bushing 35 fixed to the inner plates 32, and press-fit into pin holes 38 in the outer portions 37b of an offset plates 37 and pin holes 42 in one end portion of each of the reinforcing connecting plates 41. A bushing 35 is attached to the bushing holes 39 in the inner plate portions 37c of the offset plates 37. The pin 40 inserted through the bushing 35 is press-fit to the pin holes 45 of the outer plates 33, and the ends of the pin 40 are inserted, with play, into the small bushings 43 attached to the holes 44 of the reinforcing connecting plates 41. Rollers 34 are provided on the bushings that extend across the chain.

In the chain, the pin 36, secured to the offset plates 37 and the reinforcing connecting plates 41, is inserted through a bushing 35. The pin 40, secured to the outer plates 33, is inserted through a bushing 35 and small bushings 43. Accordingly, in the connecting portion, the outer plates 33 and the inner plates 32 can articulate with respect to the offset plate 37 and the reinforcing connecting plate 41.

When a large force is applied to the ends of the pin 40 as a result of the application of tension, the pin 40 is liable to be bent since the ends of the pin 40 are is fitted into the small bushings 43 with play. When ends of the pin 40 are bent, they may be pulled out of the small bushings 43 in the reinforcing connecting plates 41, and the pins 40 may become disengaged from the reinforcing connecting plates 41. When a pin 40 becomes disengaged from a reinforcing connecting plate in this manner, the tension in the chain is applied to the offset plates 37. Because the middle portion 37a of the offset plate has reduced strength because of its bends, the chain may be broken.

Another type of chain, known as a “high strength chain,” has longer inner and outer plates. The gaps between the ends of the adjacent inner plates, and the gaps between the ends of the adjacent outer plates, are smaller than the corresponding gaps in a conventional chain. However, when these gaps are decreased, there is insufficient space to accommodate the bent portion of an offset plate, and consequently an offset plate corresponding to plate 37 in FIG. 7 cannot be used.

Accordingly, objects of the invention are to solve the above-mentioned problems encountered in prior art chains; to provide an endless chain having an odd number of links, in which even if large force is applied to the chain, the chain is not liable to be broken at the connecting portion; and to provide a connecting portion even in a chain having smaller gaps between the ends of adjacent inner plates and smaller gaps between the ends of adjacent outer plates.

### SUMMARY OF THE INVENTION

In accordance with this invention, a chain having an odd number of links comprises a chain body composed of alternating inner plate links and outer plate links. Each inner plate link comprises a pair of side-by-side, spaced, inner plates, and a pair of bushings fixed to both inner plates. Each outer plate link comprises a pair of side-by-side, spaced, outer plates and a pair of connecting pins secured to both outer plates. The inner and outer plate links re connected in a series arrangement to form the chain body by the insertion of connecting pins of the outer plate links through bushings of the inner plate links. The chain body has first and second ends and terminates in inner plate links at both ends.

The chain also comprises a first connecting plate disposed on the outside of an inner plate at one end of the chain body, and a connecting link including a second connecting plate disposed on the outside of the first connecting plate and on the outside of an inner plate on the other end of said chain body.

The connecting link is formed by securing ends of a pair of long connecting pins respectively into a pair of pin-receiving holes formed in the second connecting plate. One end of the first connecting plate is connected to an inner plate link on one end of the chain body by inserting a connecting pin secured to the first connecting plate through a bushing of the inner plate link. The other end of the first connecting plate is connected to one end of the connecting link by inserting one of long connecting pins through a long bushing fixed to a bushing hole in the first connecting plate and through a spacer provided adjacent an inside face of the first connecting plate. The other end of the second connecting plate is connected to an inner plate link at the other end of the chain body by inserting the other long connecting pin through a bushing of the inner plate link at said other end of said chain body and through a spacer interposed between that inner plate link and an inside face of the second connecting plate. The first connecting plate and the inner plate link at said other end of said chain body are pivotable respectively on the long connecting pins.

The endless chain in accordance with the invention has an odd number of links, and the connecting link which joins the ends of the chain body is formed in such a manner that the ends of the long connecting pins are secured in a pair of pin holes in the second, or outer, connecting plate. Even if a very large amount of tension is applied to the chain, the long connecting pins will not be pulled out of the second connecting plate, and the chain is much less susceptible, than conventional chains having odd numbers of links, to breakage at the location at which the ends of the chain body are joined. Furthermore the first connecting plates connected to one end of the chain body, and the inner link at the other end of the chain body are pivotally connected by means of long connecting pins which are inserted into bushings. Accordingly, the contact areas are long, and wear of the long connecting pins is suppressed.

### BRIEF DESCRIPTION OF THE DRAWINGS

FIG. 1 is a plan view, partly in section of a connecting portion of a chain in accordance with a first embodiment of the invention;

FIG. 2 is the side elevational view of the chain shown in FIG. 1;

FIG. 3 is a plan view, partly in section of a connecting portion of a chain in accordance with a second embodiment of the invention;

FIG. 4 is a cross-sectional view of a portion of a chain in accordance with the invention, in which a first connecting plate and a spacer are integrally formed as a unit;

FIG. 5 is a cross-sectional view of a portion of a chain in accordance with the invention, in which a second connecting plate and a spacer are integrally formed as a unit;

FIG. 6 is a cross-sectional view of a portion of a chain in accordance with the invention, in which an inner plate and a spacer are integrally formed as a unit; and

FIG. 7 is a plan view, partly in section, of a connecting portion of a conventional chain.

### DETAILED DESCRIPTION OF THE PREFERRED EMBODIMENTS

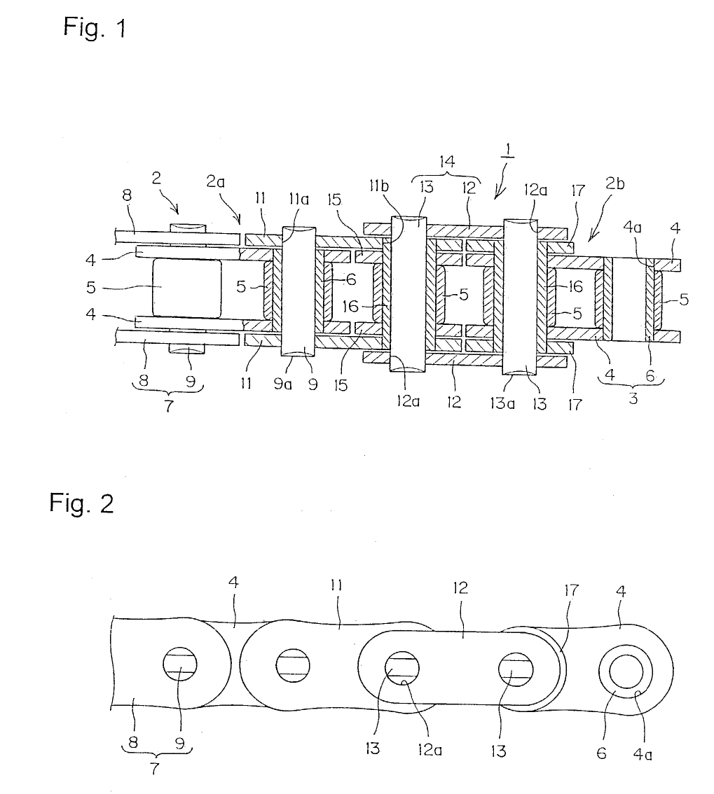

In a first embodiment of the invention, shown in FIGS. 1 and 2, ends 2a and 2b of a chain body 2 are connected to each other to form an endless chain 1. The chain body is composed of a plurality of inner links 3 and outer links 7 connected to one another by connecting pins 9. The ends of the chain body are connected to each other by a connecting link 14.

Each inner link 3 is formed by press-fitting a pair of bushings 6 into bushing holes 4a in a pair of inner plates 4. A roller 5 is fitted to each bushing 6 with play. Each outer link 7 is formed by press-fitting a pair of connecting pins 9 into pin holes in a pair of outer plates 8. The chain body 2 is formed by connecting the inner and outer links to each other in alternation along a longitudinal direction of the chain by inserting connecting pins 9 of the outer links 7 through bushings 6 of the inner links 4.

To complete the endless chain 1, the ends 2a and 2b of the chain body 2 are connected to each other by the connecting link 14, which comprises a pair of first connecting plates 11 and a pair of second connecting plates 12. The first connecting plates 11 are disposed outside the inner link 3 at one end of the chain body 2, and the second connecting plates 12 are disposed outside the first connecting plates 11. Thus, the connecting plates 12 are disposed on the outermost part of the chain. The chain 1 is effectively composed of an odd number of links by the addition of the connecting link 14.

A pair of long connecting pins 13 is press-fit into pin holes 12a of a pair of second connecting plates 12. A pin hole 11a is provided in an end portion of each of the first connecting plates 11, and a bushing hole lib is provided in the other end portion of each of the first connecting plates 11. A pin 9, is inserted though a bushing 6 of the inner link 3 at end 2a of the chain body 2. The ends 9a of this connecting pin 9 are fitted to the pin holes 11a at the end portions of the first connecting plates 11. A long bushing 16 is fitted to bushing holes 11b at the other end portion of the first connecting plate 11. Disc-shaped spacers 15, which are in contact with a roller 5 surrounding bushing 16, are provided on the inside faces of the first connecting plates 11. The long bushing 16 extends through these spacers 15, and may be either secured to the spacers, or extend through the spacers with play.

The long connecting pin 13 secured to the left end portions of the second connecting plate 12 as seen in FIG. 1 is inserted through the long bushing 16, which is fixed to the bushing holes lib of the first connecting plate 11. The long connecting pin 13 secured to the right end portions of the second connecting plates 12 is inserted through another long bushing 16 which protrudes through the inner plate 4 at the other end portion 2b of the chain body 2. A second disc-shaped spacer 17 is provided adjacent the inside faces of the second connecting plates 12, between the second connecting plates 12 and the inner plates 4 of the inner link 3 at end portion 2b of the chain body 2. Spacer 17 can be either fitted to the long bushing 16 or rotatable thereon.

Because the connecting portion is constructed as described above, the first connecting plates 11 and the inner link 3 at end portion 2b of the chain body 2 are pivotable relative to the long connecting pins 13, and therefore the chain 1 is articulated at its connecting portion. When tension is applied to the chain, since the long connecting pins 13 are secured to the second connecting plates 12, the long connecting pins 13 cannot be pulled out of the holes in plates 12 and breakage of the chain at the connecting portion is prevented.

Because each of the long connecting pins 13 is inserted through along bushing 16, the contact area of the pins 13 with the long bushings 16 is long, and wear is suppressed. Moreover, because the long connecting pins 13 are secured to the second connecting plate 12, both the inner links 3, and outer links 7, of the chain body 2 can have the same strength, so that breakage of the chain at the connecting portion can be prevented.

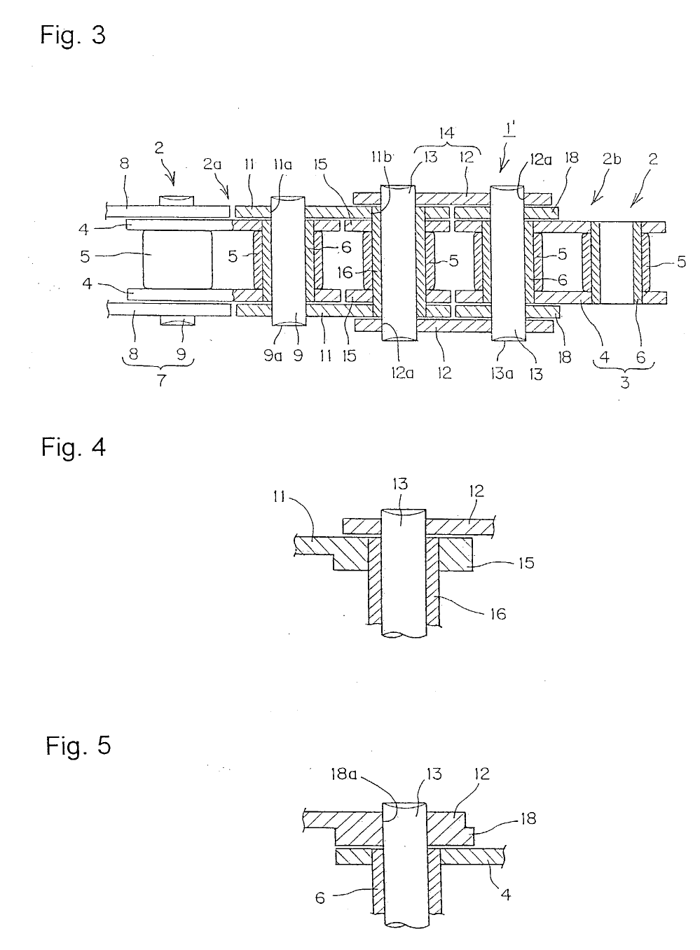

In the alternative embodiment shown in FIG. 3, chain components corresponding to those of FIG. 1 are designated by the same reference numerals. The chain 1′ in FIG. 3 is different from the chain 1 in FIG. 1 in that, instead of mounting the spacer 17 onto the long bushing 16, a spacer 18 is either secured to a long connecting pin 13, or fitted onto the long connecting pin with play.

In FIG. 3, ends 2a and 2b of a chain body are connected to each other to form an endless chain. The chain 1′ is formed by connecting inner links 3 and outer links 7 to one another using connecting pins 9. The ends of the chain are connected by a connecting link 14, having first connecting plate 11 and a second connecting plate 12.

Each inner link 3 is formed by press-fitting a pair of bushings 6 into bushing holes 4a in a pair of inner plates 4. A roller 5 is fitted to each bushing 6 with play. Each outer link 7 is formed by press-fitting a pair of connecting pins 9 into pin holes in a pair of outer plates 8. The chain body 2 is formed by connecting the inner and outer links to each other in alternation along a longitudinal direction by inserting connecting pins 9 of the outer links 7 through bushings 6 of the inner links 4. Rollers 5 fit onto the bushings 6 with play.

To complete the endless chain 1′, the ends 2a and 2b of the chain body 2 are connected to each other by the connecting link 14, which comprises a pair of first connecting plates 11 and a pair of second connecting plates 12. The first connecting plates 11 are disposed outside the inner link 3 at one end of the chain body 2, and the second connecting plates 12 are disposed outside the first connecting plates 11. In the connecting link 14, two long connecting pins 13 are press-fit into pin holes 12a of a pair of second connecting plates 12.

Pin holes 11a, of an inner link 3 at one end of the chain body, are provided in end portions of connecting plates 11, and bushing holes 11b are provided in the other end portions of plates 11. Pin 9 is inserted through the bushing 6, and ends 9a of pin 9 are secured to pin holes 11a. Ends of a long bushing 16 are fixed in bushing holes 11b in plates 11. Disc-shaped spacers 15 are provided on the inside faces of the connecting plates 11, in contact with a roller 5. The long bushing 16 extends through these spacers 15, and may be either secured to the spacers, or extend through the spacers with play.

The long connecting pin 13, which is secured to the left end portions of the second connecting plates 12, is inserted through the long bushing 16 which fixed to the bushing holes 11b of the first connecting plates 11. The other long connecting pin 13, which is secured to the right end portions of plates 12, is inserted through the bushing 6 of the inner link 3 at end portion 2b of the chain body 2. Disc-shaped spacers 18 are provided on the inside faces of the second connecting plate 12, between the second connecting plate 12 and the inner plate 4 of the inner link 3 at end portion 2b of the chain body 2. The spacer 18 may be either fixed to the long bushing 16 or rotatable thereon.

When the connecting portion is constructed as described above, the first connecting plates 11, and the inner link 3 at the other end portion 2b of the chain body 2, are both pivotable on long connecting pins 13, and the chain 1′ is articulated at the connecting portion. When tension is applied to the chain 1′, since the long connecting pins 13 are secured to the second connecting plates 12, the long connecting pins 13 do not become disengaged from the plates 12, and breakage of the chain 1′ at the connecting portion is prevented

Since the long connecting pins 13 are inserted through bushings 6 and 16, the contact areas between the pins 13 and the bushings are long, and wear is reduced. Furthermore, since the long connecting pins 13 are secured to the second connecting plate 12, the inner links 3 and outer links 7, which form the chain body 2, can have the same strength, so that breakage of the chain at the connecting portion is prevented.

In the first and second embodiments described above, the spacer 15, provided on the inside faces of end portions of the first connecting plates 11, and the spacers 17 and 18, provided on the inside faces of end portions of the second connecting plates 12, are provided as elements separate from the connecting plates. However, as an alternative, a spacer and a plate may be formed as a unit, so that a spacer may be provided as an integral part of a connecting plate 11, 12, or 4, as shown respectively in FIGS. 4, 5, and 6.

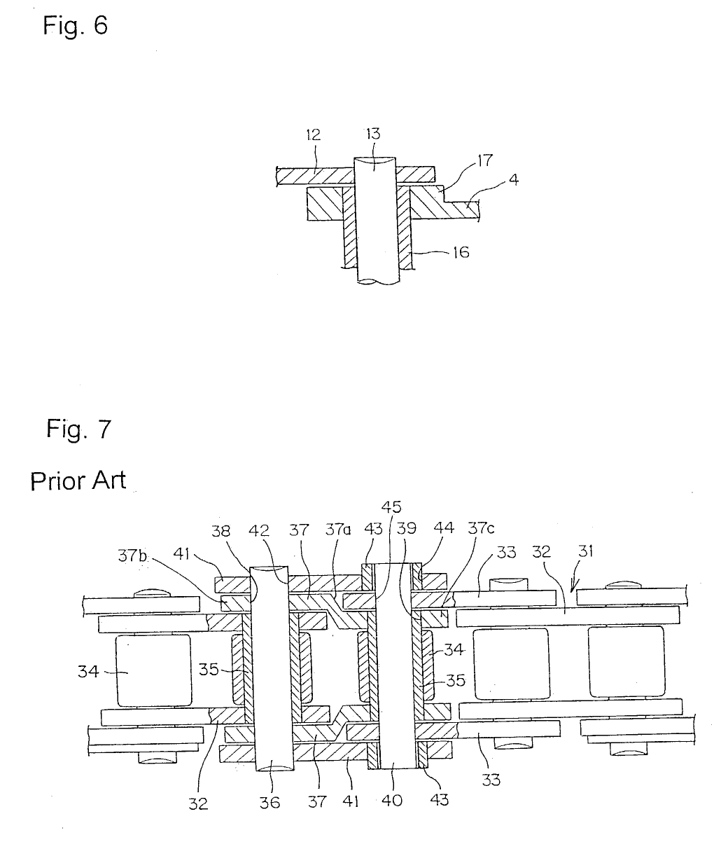

As shown in FIG. 4, a first connecting plate 11 may be integrally formed with a spacer 15 and fitted onto a long bushing 16 with play. As shown in FIG. 5, a second connecting plate 12 may be integrally formed with a spacer 18, and a long connecting pin 13 may be secured to a pin hole 18a, which extends through the part of the connecting plate 12 that includes the spacer 18. As shown in FIG. 6, an inner plate 4 at an end portion of the chain body may be integrally formed with a spacer 17 and fitted to a long bushing 16 with play.

These spacers may be disc-shaped, or can have other shapes such as an oval or rectangular shape. The length of the spacer is preferably substantially half the length of the plate of which it is an integral part. The thickness of the spacer is preferably substantially the same as the thickness of the other end of the plate.

In the chain according to the invention, the first connecting plates, and the inner link at the other end of the chain body, are both pivotable with respect to the respective long connecting pins of the connecting link so that the chain can be articulated or bent in the connecting portions. Furthermore, when tension is applied to the chain, since the ends of the long connecting pin are secured to a pair of pin holes in the second connecting plates, the long connecting pins cannot be pulled out of the second connecting plates. Accordingly, breakage of the chain at the connecting portion is prevented. Since the long connecting pins are inserted in bushings, the contact areas of the long pin with the bushings are large, and consequently chain breakage due to wear is prevented.

Because the connecting link formed is formed by securing long connecting pins to the second connecting plates, the inner and outer links, which form the chain body, can have the same strength, so that further assurance is provided against chain breakage at the connecting portion.

Because the spacers provided inside the second connecting plates of the connecting link have no bents portions, unlike the offset plate in the prior art, the spacer can be provided in various shapes. Thus, it can be disc-shaped, oval, or rectangular, for example. Finally, the spacer can be applied to chains having small gaps between the ends of the adjacent inner plates and between ends of the adjacent outer plates.

I claim:

1. A chain having an odd number of links, the chain comprising a chain body composed of alternating inner plate links and outer plate links,
each inner plate link comprising a pair of side-by-side, spaced, inner plates, and a pair of bushings fixed to both inner plates of said pair, and
each outer plate link comprising a pair of side-by-side, spaced, outer plates, and a pair of connecting pins secured to both outer plates of said pair of said outer plates,
said inner and outer plate links being connected in a series arrangement to form said chain body by the insertion of connecting pins of the outer plate links through bushings of the inner plate links; and
said chain body having first and second ends and terminating in inner plate links at both ends;
said chain also comprising:
a first connecting plate disposed on the outside of an inner plate at one end of said chain body and a connecting link including a second connecting plate disposed on the outside of the first connecting plate and on the outside of an inner plate on the other end of said chain body, characterized in that:
said connecting link is formed by securing ends of a pair of long connecting pins respectively into a pair of pin-receiving holes formed in the second connecting plate;
one end of said first connecting plate is connected to an inner plate link on one end of said chain body by inserting a connecting pin secured to the first connecting plate through a bushing of said inner plate link;
the other end of said first connecting plate is connected to one end of said connecting link by inserting one of long connecting pins through a long bushing fixed to a bushing hole in the first connecting plate and through a spacer provided adjacent an inside face of said first connecting plate;
the other end of said second connecting plate is connected to an inner plate link at the other end of said chain body by inserting the other long connecting pin through a bushing of said inner plate link at said other end of said chain body and through a spacer interposed between the said inner plate link at said other end of said chain body and an inside face of the second connecting plate; and
said first connecting plate and said inner plate link at said other end of said chain body are pivotable respectively on said long connecting pins.
